(19) United States
(12) Patent Application Publication
(10) Pub. No.: US 2020/0302951 A1
(43) Pub. Date: Sep. 24, 2020

(54) ACTIVITY RECOGNITION SYSTEM FOR SECURITY AND SITUATION AWARENESS

(71) Applicants: Yunbin Deng, Westford, MA (US); Bo Yuan, Acton, MA (US)

(72) Inventors: Yunbin Deng, Westford, MA (US); Bo Yuan, Acton, MA (US)

(73) Assignee: Wave2Cloud LLC, Carlisle, MA (US)

(21) Appl. No.: 16/822,165

(22) Filed: Mar. 18, 2020

Related U.S. Application Data
(60) Provisional application No. 62/819,743, filed on Mar. 18, 2019.

(51) Int. Cl. G10L 25/51; G06T 5/00; G06T 7/70; H04R 3/04; G06K 9/00; G08B 3/10

(52) U.S. Cl. CPC G10L 25/51; G06T 5/007; G08B 3/1016; H04R 3/04; G06K 9/00624; G06T 7/70

(57) ABSTRACT

A sound-based activity recognition system has the potential to better detect and identify activity in an environment compared to video-only monitoring systems. However, conventional sound recognition systems are typically unable to provide sound recognition using a single device and have limited user control of data and video integration. These shortcomings may be overcome by a sound-based activity recognition system that incorporates computationally inexpensive methods to detect and identify sounds that can be performed on a single electronic device. The activity recognition system may further provide object recognition to enable both sound and object detection. In one example, the activity recognition system may include a microphone and a camera to record audio and video from the environment and a processor to filter background noise, which reduces the amount of data processed; to identify sounds and objects using a model; and to notify a user of the sounds and objects detected.

### CROSS-REFERENCE TO RELATED PATENT APPLICATION(S)

This application claims priority to U.S. Provisional Application No. 62/819,743, filed on Mar. 18, 2019, entitled “A SOUND RECOGNITION SYSTEM FOR SECURITY AND SITUATION AWARENESS,” which is incorporated herein by reference in its entirety.

### BACKGROUND

Conventional security systems are typically based on imaging technology alone. Although these systems can detect motion, the false alarm rate is often high. The high false alarm rate is, in part, due to the inability of such systems to distinguish between security-related events (e.g., a person breaking into a home or business) and non-security related events (e.g., an animal moving through a backyard). Additionally, changes to lighting conditions (e.g., the motion of a lighting fixture can cause shadows to correspondingly move) may also cause false detections of a security risk. In order to reduce the false alarm rate of conventional security systems, it is preferable to have at least one user continuously monitor the video stream, which can lead to high labor and infrastructure costs.

### SUMMARY

One approach towards a more intelligent security system is to utilize sound recognition in order to better identify and distinguish activity in the environment that may pose a security risk. Recent advances in sound recognition technologies have enabled higher accuracy in recognizing many sounds (e.g., voice, coughing, a musical instrument, an alarm, environmental noise, a door opening/closing). The higher accuracy of sound recognition technologies also engenders a more automated sound monitoring system with less supervision.

However, conventional systems that rely on sound recognition are typically designed for a specific application where the user should purchase and install proprietary hardware. The installation of proprietary hardware may be cumbersome and costly. Conventional sound recognition systems are also limited in terms of the number of sounds that can be identified. For example, car alarm detectors have been developed with sound recognition capabilities but are configured to only detect a repeating car alarm sound.

Additionally, conventional sound recognition systems are typically unable to perform sound recognition on a single device (e.g., a laptop, a mobile phone). Rather, conventional sound recognition systems typically include a device located in an environment to record audio from the environment and a physically separate server to perform sound recognition. The device typically transmits the recorded audio to the server via an Internet connection. If the device is disconnected from the Internet, these conventional sound recognition systems are unable to provide sound recognition. Furthermore, conventional sound recognition systems also limit a user's control of the data by transmitting recorded audio to a server for subsequent processing, which may lead to unwanted risks and/or exposure of the user's data.

The present disclosure is thus directed to an activity recognition system (also referred to as the “Wave2Cloud system”) and methods and uses of the system. The activity recognition system may provide sound-based activity recognition (e.g., a window breaking, a person coughing) based on recorded audio, object-based recognition (e.g., a person, a car) based on recorded imagery, and/or video-based activity recognition (e.g., a person moving or walking, a car moving) based on a series of images. The activity recognition system may only provide sound-based activity recognition. The activity recognition system may provide both sound-based activity recognition and object-based recognition and/or video-based activity recognition to further enhance detection and identification of activity in an environment based on visual and auditory data.

The activity recognition system may include an activity detector such as a computer or a smartphone. The activity detector may include a microphone to record an audio stream, a camera to record imagery or video, and a processor to detect and identify sounds and/or objects from the audio, imagery, and/or video, and a transmitter to send a message notifying a user that a particular sound of interest and/or object of interest is detected. The activity recognition system may also include an activity receiver (also referred to herein as “alert receiver”), such as a computer or a smartphone, to receive the message and to allow a user to access and/or configure the activity recognition system to meet their preferences.

The activity detector may record the audio stream and locally perform processes via the processor to detect and identify sounds in the audio stream. Said in another way, the activity detector may process the audio stream locally without using another processor, computer, or server that is physically separate from the activity detector to perform sound recognition. In this manner, the activity detector can provide audio recording, sound detection and identification without being communicatively coupled to another device. For example, the activity detector can still record audio and perform sound recognition without an Internet connection.

For some systems, the activity receiver may receive the message directly from the activity detector. For some systems, the activity recognition system may include a server communicatively coupled to the activity detector and the activity receiver solely to receive and store the message and to transmit the message to the activity receiver. The server is not used to detect and/or identify sounds recorded in the audio stream.

The activity recognition system may be used as an automated security system for a home, a school, a public area, or a business. The activity recognition system may also be used to improve situational awareness of an environment. The activity recognition system disclosed herein is not limited to applications related to security or situational awareness, but can also apply to other applications including, but not limited to healthcare (e.g., monitoring sound-related symptoms, sleep quality), baby monitoring (e.g. monitoring whether an infant is sleeping or crying), animal/pet monitoring, assisted hearing for the deaf, assisted vision for the blind, and as an auxiliary safety system for a vehicle. The activity recognition system may also operate using various hardware ranging from proprietary hardware with specific sound and video processing specifications to general consumer electronics such as a personal computer, a smartphone, a tablet, or a video game console. For example, the activity detector may be a computer and the activity receiver a smartphone. For consumer electronics, the activity recognition system may be installed by users using various methods, such as downloading the software component through an app store.

The activity recognition system may spectrally filter out background noise in order to reduce the false alarm rate for sound detection (e.g., the false alarm rate may be less than about 1%). Compared to conventional security recognition systems, the low false alarm rate substantially increases the reliability of the activity recognition system. As a result, the activity recognition system may be deployed as a fully automated system where a user no longer has to continuously monitor the data stream in order for the system to be accurate and effective.

The activity recognition system may also filter out background noise (e.g., white noise) to reduce the amount of audio data processed by the activity recognition system, thus increasing the computational efficiency of the processor (i.e., the processor uses fewer resources to perform an operation). The higher computational efficiency enables, at least in part, the activity recognition system to operate in real time even when utilizing general consumer electronic devices. Real time operation may be defined, for example, as the time between the activity detector initially detecting a sound and the activity receiver receiving a message alerting a user of the detected sound, which can be less than about 1 second. In some instances, the time to detect and identify a sound and/or object and to generate a message may be substantially faster than the time for the message to be received by the activity receiver (e.g., the time for a smartphone to receive a text message or a computer to receive an email).

Sound segments (also referred to herein as “audio segments”) are automatically detected and may be classified as containing zero, one, or multiple sounds. The activity recognition system may be configured to save the sound segments locally onto the activity detector when the sound of interest is recognized.

In addition, the activity detector may include a camera for object detection and recognition. In some cases, when a sound of interest is detected, the camera may be triggered to capture a photo or a video of the environment. Alternatively, when an object of interest is detected, the microphone may be triggered to record audio of the environment. The audio, imagery, and/or video may be saved locally onto the activity detector. The camera may be physically integrated into the activity detector may be connected externally (e.g., with a physical connection or wirelessly) to the processor. The activity detector may include other types of sensors including, but not limited to, an accelerometer, or a vibration sensor. These sensors may also be configured to respond when the sound of interest and/or object of interest is detected.

The activity recognition system may also distinguish between multiple sounds that overlap in time and/or in frequency. The activity recognition system may also compensate for environmental-based sound effects, such as reverberations or echoes.

The activity recognition system may also be customized by a user depending on the particular application. For example, the activity recognition system may be calibrated to identify hundreds of sounds including variations of one type of sound including, but not limited to, variations in the tone and pitch of a person's voice, human activity, sound generated by animal vocalization and activity, sound of musical instruments, sound made by many machineries, and natural sounds. The activity recognition system may also be calibrated to identify hundreds of objects. A user may select a subset of these sounds and/or objects for detection. Once the user selects the sounds and/or objects, the activity recognition system will only transmit a message to the activity receiver when those sounds or objects are detected. Thus, the activity recognition system can be configured for several applications depending on the user's preference. These applications, as described above, include, but are not limited to smart homes, home security, baby care, pet care, and assisted hearing for the deaf.

A message notifying a user that a sound of interest and/or object of interest is detected may also be delivered to the activity receiver in various formats including, but not limited to, a text message, an email, and a messenger app. While the message can be delivered in real-time, as described above, the user may also configure the activity recognition system to deliver messages over preset time periods (e.g., a day, a week, during daytime hours only, during time periods when a user is away from their home).

The activity recognition system may also enable a user to better control data privacy. For example, the activity detector may perform both the sensory data acquisition and computation locally (e.g., without use of an external server). Thus, the data within the activity recognition system may be stored on the activity detector, which can be configured to communicate with the activity receiver through a port on a secured network (e.g., a home wireless network). The activity recognition system may also be configured to operate with a cloud server to store audio segments, photos, or videos. Depending on the user's preferences, the activity recognition system may send to the activity receiver a text-based message, an audio segment, a photo, or a video.

The activity recognition system may operate and be accessible using various operating systems including, but not limited to, Microsoft Windows (e.g., Windows 10 app store), Google Android (Android app store), and Apple iOS (Apple store).

In one example, a method of detecting and identifying at least one sound of interest includes the following steps: (1) recording an audio stream using a microphone in an activity detector, (2) detecting a sound from the audio stream using a processor disposed in the activity detector where the processor is operably coupled to the microphone, (3) identifying at least one predetermined sound in the plurality of predetermined sounds from the sound using the processor in response to detecting the sound, (4) comparing the at least one predetermined sound to the at least one sound of interest using the processor, (5) generating a message using the processor in response to matching the at least one predetermined sound to at least one sound of interest, (6) transmitting the message using a transmitter coupled to the processor, and (7) receiving the message using an activity receiver. A similar process with similar steps may be applied to detect and identify objects in image(s) or video.

The another example, a method of detecting and identifying at least one sound of interest includes the following steps: (1) recording an audio stream using a microphone in an activity detector, (2) detecting a sound from the audio stream using a processor disposed in the activity detector where the processor is operably coupled to the microphone, (3) identifying at least one predetermined sound in the plurality of predetermined sounds from the sound using the processor in response to detecting the sound, (4) comparing the at least one predetermined sound to the at least one sound of interest using the processor, (5) generating a message using the processor in response to matching the at least one predetermined sound to at least one sound of interest, (6) transmitting the message using a transmitter coupled to the processor, (7) receiving and storing the message using a server operably coupled to the activity detector and the activity receiver, and (8) transmitting the message from the server to the activity receiver. Before transmitting the message using the transmitter coupled to the processor, the processor in the activity detector does not communicate with another processor that is physically separate from the activity detector.

In another example, an activity recognition system includes an activity detector configured to identify a plurality of predetermined sounds where the plurality of predetermined sounds includes at least one sound of interest and an activity receiver operably coupled to the activity detector to receive a message generated by the activity detector. The activity detector includes a microphone to record an audio stream, a processor electrically coupled to the microphone, and a transmitter electrically coupled to the processor to transmit the message. The processor is configured to: (1) detect a sound from the audio stream, (2) identify at least one predetermined sound in the plurality of predetermined sounds from the sound, and (3) generate the message in response to matching the at least one predetermined sound to the at least one sound of interest.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a diagram of an exemplary activity recognition system.

FIG. 2 shows an exemplary graphical user interface (GUI) on a computer for a user to login/register access to the activity recognition system.

FIG. 3 shows an exemplary GUI to choose at least one sound of interest amongst a library of sounds the activity recognition system is trained to detect and identify.

FIG. 4 shows a diagram of the activity detector in the activity recognition system of FIG. 1.

FIG. 5 shows a flow chart of a process to train a sound recognition model used to identify multiple sounds.

FIG. 6 shows an exemplary GUI on a smartphone for a user to login/register access to the activity recognition system.

FIG. 7 shows an exemplary GUI on a smartphone for a user to select one or more applications of the activity recognition system including pet care, baby care, home security, health care, and advanced options.

FIG. 8 shows an exemplary GUI on a smartphone for a user to select sounds of interest.

FIG. 9 shows an exemplary GUI on a smartphone for a user to select objects of interest.

### DETAILED DESCRIPTION

Following below are more detailed descriptions of various concepts related to, and implementations of an activity recognition system that provides automated monitoring of various sounds of interest and/or objects of interest at low false alarm rates and message generation capabilities to alert a user when sounds of interest and/or objects of interest are detected and methods for configuring and using the activity recognition system. Specifically, an activity detector, an activity receiver, an alert configurator, a local service, a web-based service (e.g., a cloud service), and various methods and processes using the foregoing components are described herein. The concepts introduced above and discussed in greater detail below may be implemented in multiple ways. Examples of specific implementations and applications are provided primarily for illustrative purposes to enable those skilled in the art to practice the implementations and alternatives apparent to those skilled in the art.

The figures and example implementations described below are not meant to limit the scope of the present implementations to a single embodiment. Other implementations are possible by interchanging some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive activity recognition systems are provided, wherein a given example or set of examples showcases one or more particular features of an activity detector, an activity receiver, and a processor. One or more features discussed in connection with a given example of an activity detector, an activity receiver, and a processor may be employed in other examples of activity detectors, activity receivers, and processors, such that the various features disclosed herein may be readily combined in a given activity recognition system according to the present disclosure (provided that respective features are not mutually inconsistent).

### 1. An Exemplary Activity Recognition System

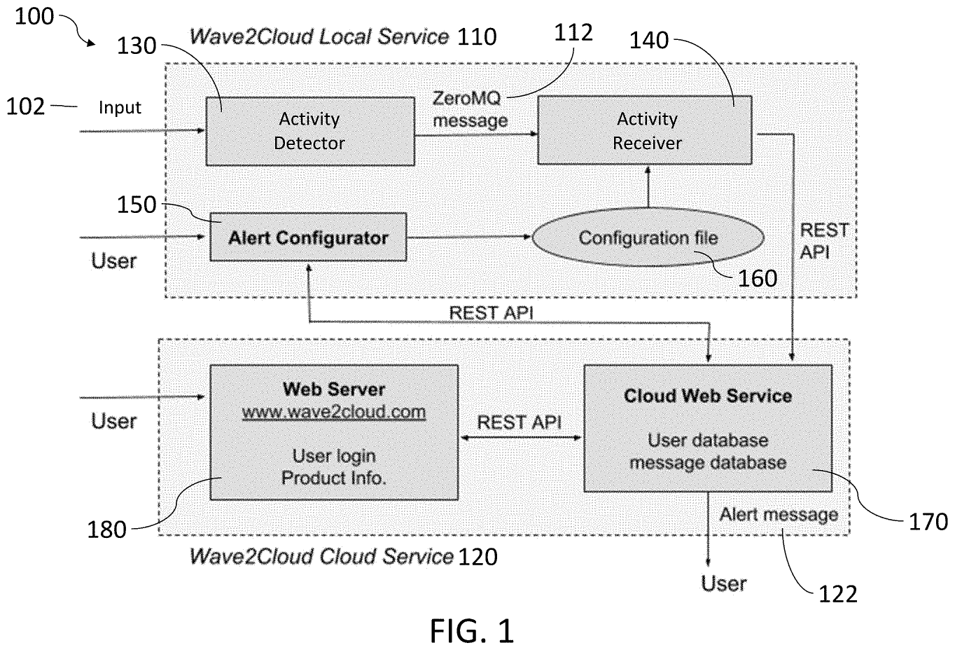

FIG. 1 shows a diagram of an exemplary activity recognition system 100. The exemplary activity recognition system 100 may include a server 180. As shown, the various components of the activity recognition system 100 may be organized into two functional blocks: (1) the Wave2Cloud local service 110 shown on the top and (2) the Wave2Cloud cloud service 120 shown on the bottom.

The local service 110 may include both the activity detector 130 and the activity receiver 140. As shown in FIG. 1, the local service 110 may allow messages 112 to be sent from the activity detector 130 to the activity receiver 140 (e.g., a ZeroMQ message generated using a ZeroMQ messaging library) and for the user to reconfigure the activity recognition system 100 by selecting sounds and/or objects of interest from the library of sounds the activity recognition system 100 is trained to identify. Depending on the application, the activity detector 130 and the activity receiver 140 may be separate devices or integrated as a single device. For example, for security related applications, the activity detector 130 may be a tablet installed in a business and the activity receiver 140 may be a laptop the user uses at a remote location (e.g., their home). In another example, for applications related to assisted hearing for the deaf, a single device may be used to display sounds and/or objects detected near the user.

The cloud service 120 may include a server 180. As shown in FIG. 1, the cloud service 120 may include the cloud web service 170 to facilitate user management, storage for messages, audio segments, photos, or videos, as well as to control access to each user's account. The local service 110 may communicate with the cloud service 120 using a REpresenational State Transfer (REST) Application Programming Interface (API).

In other activity recognition systems, the activity detector 130 and/or the activity receiver 140 may also store messages, audio segments, images, or videos locally. Furthermore, messages, audio segments, images, or videos may be directly transmitted from the activity detector 130 to the activity receiver 140 without use of the server 180.

### 1.1 Activity Detector

The activity detector 130 (also referred to herein as “alert monitor 130”) records an input 102 and identifies sounds and/or objects in the input 102. The input 102 may include an audio stream, an image, and/or a video stream (i.e., a sequence of images). For example, the activity detector 130 may record an audio stream in the input 102 using a microphone, apply signal processing (e.g., various types of filters) to detect sound activity from the audio stream using a processor, and identify sounds from audio segments by applying classification techniques (e.g., deep learning techniques) to the audio stream. In another example, the activity detector 130 may record a video stream in the input 102 and apply image processing (e.g., normalizing the brightness of an image particularly for low visibility environments such as a dark room, monitoring changes between images to avoid transmitting nearly identical images with no new information) to images captured by the activity detector 130 using the processor. The processor may also generate a message 112 when a sound or object is detected. A transmitter in the activity detector 130 may be used to send the message 112 as a ZeroMQ message to the activity receiver 140.

The activity detector 130 may be a single device, such as a personal computer, a laptop, or a mobile phone that performs both sound recording and sound recognition. The activity detector 130 does not depend on another device, such as a server, to perform sound recognition. In other words, the activity detector 130 can provide sound recognition without an Internet connection. For example, a user may bring their phone to a remote area where the phone is disconnected from a mobile network and still perform sound recognition to identify various species of animals in the remote area.

The operation of the activity detector 130 may be designed to run as a background process, allowing the user to use the activity detector 130 as an electronics device. For example, the activity detector 130 may be a computer with a microphone and a camera. While the user is using the computer, the computer may detect sounds from the environment and record audio and video of the environment. The activity detector 130 may include other types of sensors including, but not limited to, an accelerometer, or a vibration sensor. These sensors may also be configured to respond when the sound of interest and/or object of interest is detected (e.g. monitoring vibrations when a door is opened or closed).

### 1.2 Activity Receiver

The activity receiver 140 receives the message 112. The activity receiver 140 may be coupled to the activity detector 130 through a message queue system (e.g., the ZeroMQ messaging library). The activity receiver 140 may also be coupled to the cloud web service 170 through a REpresentational State Transfer Application Programming Interface (REST API). When a message 112 is received, the activity receiver 140 records it to a local log file and also sends a notification to the cloud web service 170 through the REST API. Depending on the operating system, the alert monitor 130 and the alert receiver 140 may be combined using a single service. For example, in a Microsoft Windows operating system, both the alert monitor 130 and the alert receiver 140 are wrapped under the Wave2Cloud Windows service. The activity receiver 140 is also designed to run the alert monitor 130 and the alert receiver 140 as background processes, thus allowing the user to use the activity receiver 140 as an electronics device. For example, the activity receiver 140 may be a computer, which can be used normally by a user. When a message 112 is received, the computer may notify the user by sending an alert message 122 based on the message 112.

### 1.3 Alert Configurator

The alert configurator 150 allows a user to select the sounds and/or objects of interest from the library of sounds and/or objects the activity recognition system 100 is trained to identify. The alert configurator 150 may be designed to have multiple profiles to allow the user to more easily switch between applications and/or sound and object profiles.

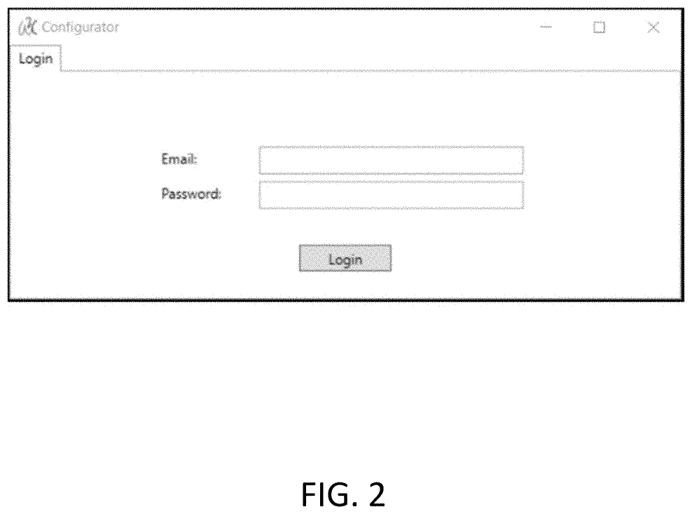

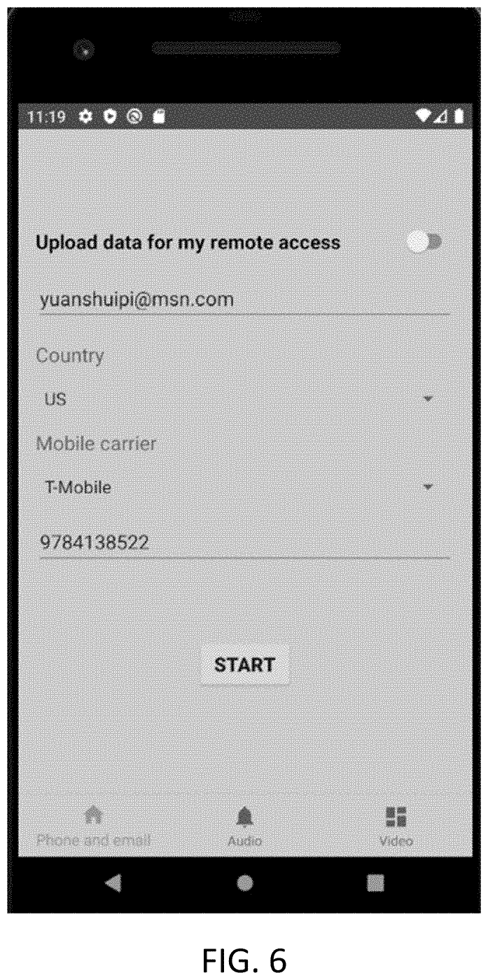

The alert configurator 150 may also be coupled to the cloud web service 170 through the REST API. The alert configurator 150 is also used to facilitate user registration and access to an account on the cloud service 120. For example, a two-step procedure may be used to register a user and configure the activity recognition system 100. The first step is for a user to sign up or login to the cloud service. FIGS. 2 and 6 shows exemplary graphical user interfaces (GUI) for the Wave2Cloud App Signup/Login screen on a computer and a smartphone, respectively.

FIG. 2 shows the user may input an email address and a password to setup an account or login. For signup, a verification email is sent to the user and the user clicks on a link in his/her email to confirm ownership of the email address. The email and password may also be used to log into a web portal for the activity recognition system 100. FIG. 6 shows the user may also input their country of residence and a phone number to receive a verification message and subsequent alert messages 122 on their phone.

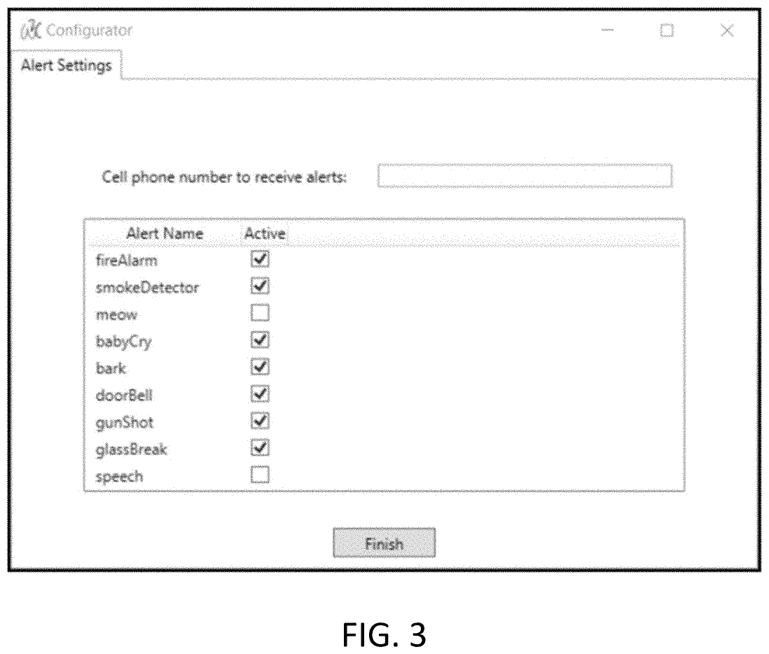

The second step is to configure the sounds of interest and/or objects of interest a user would like the activity recognition system 100 to detect, which is stored in a configuration file 160. The sound of interests may include a variety of verbal and/or non-verbal sounds including, but not limited to speech, a person walking, an object falling onto the ground, an alarm, gusts of wind, or thunder. FIG. 3 shows an exemplary GUI for a user to select one or more sounds of interest from a library on a display of a personal computer or laptop. In the exemplary GUI shown in FIG. 3, the user configured the activity recognition system 100 to detect sounds for home security, baby care, and pet care. If the phone number is not specified, the alert message 122 may be sent to the user's registered email address only. The activity recognition system 100 may allow the user to change the sounds and/or objects at any time after the configuration is setup. For example, the user can change the setting of the activity recognition system 100 through the web portal.

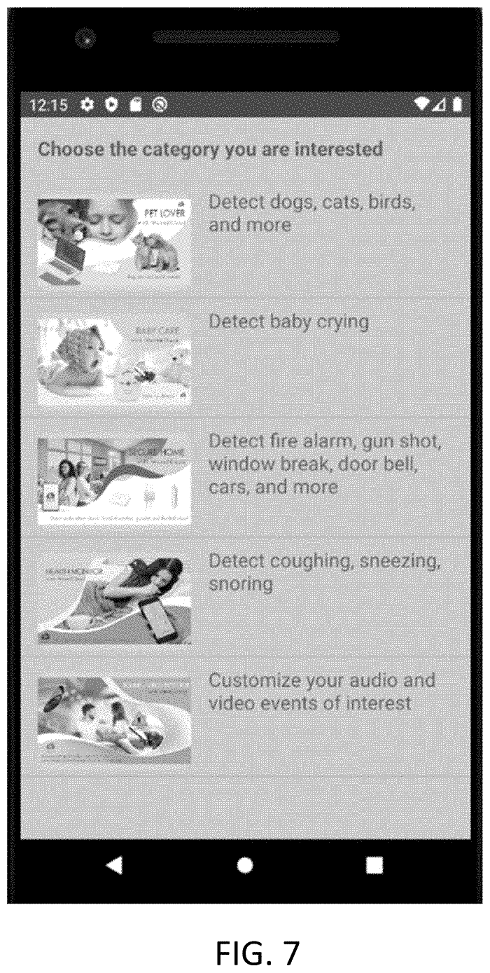

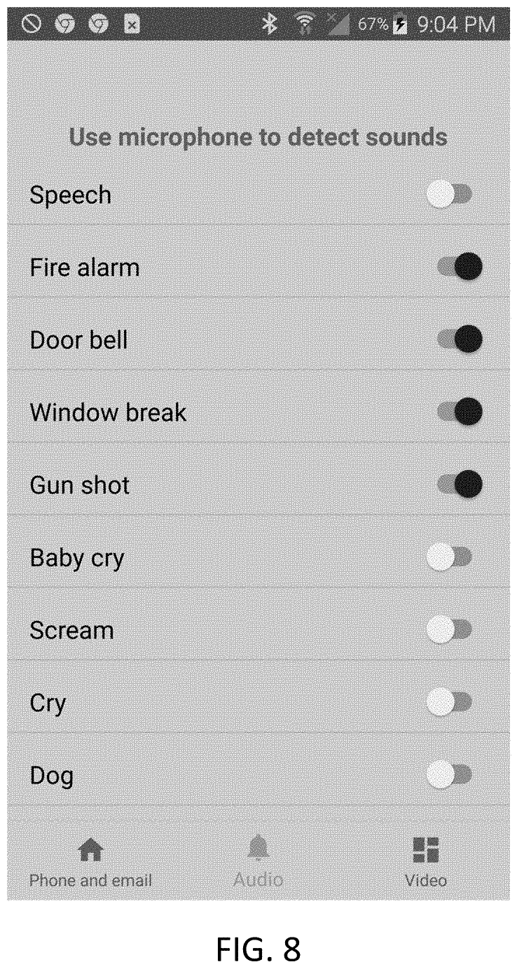

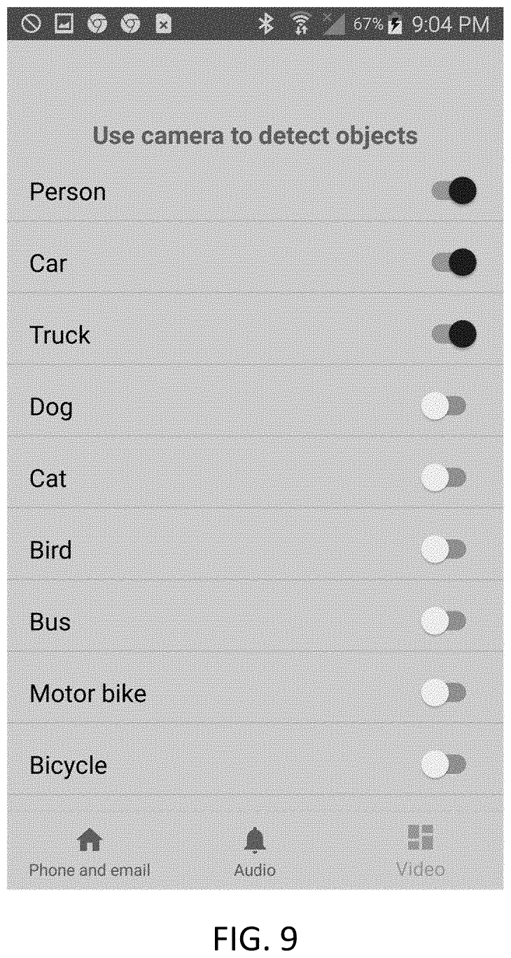

FIGS. 7-9 show additional exemplary GUIs for a user to select sounds of interest and objects of interest using a smartphone. FIG. 7 shows various categories of sounds and/or objects including, but not limited to pet care, baby care, home security, health care, and a user customized profile that a user can select to customize the activity recognition system 100. FIG. 8 shows a GUI that allows a user to select different sounds for detection. FIG. 9 shows a GUI that allows a user to select different objects for detection.

The user may provide inputs to the activity recognition system 100 using the activity detector 130 and/or the activity receiver 140 using various input devices including, but not limited to a mouse, a keyboard, and a touchscreen.

### 1.4 Cloud Web Service

The cloud web service 170 provides the REST API to facilitate communication between the local service 110 (namely the activity receiver 140) and the server 180. The cloud web service 170 may manage the user accounts and store messages using a database. When an alert message 122 is received by the cloud web service 170, the alert message 122 may be stored on the database followed by the cloud web service 170 sending the alert message 122 as an email and/or text message to the user. Alternatively, the activity receiver 140 may directly transmit the alert message 122 to the user depending on the user's configuration of the activity recognition system 100. The message 122 may contain various information including, but not limited to, the identified sound and/or object, the time when the sound and/or object was detected, and web links to the audio, image, or video if the user allows the audio, image, or video to be uploaded an accessible through the cloud. It should also be appreciated that the features of the cloud service 120 may be integrated with the activity detector 130 and/or the activity receiver 140. For example, a personal computer may be used as both the activity detector 130 and the server 180 with the web service 170.

### 1.5 Server

The server 180 provides a web portal for the user to access and change the settings for the activity recognition system 100. The server 180 may be coupled to the cloud web service 170 through the REST web service API. The users may manage the message configuration and browse a history of alert messages 122 received on the server 180. The server 180 may be communicatively coupled to the activity detector 130 and the activity receiver 140 using various network connections including, but not limited to a local area network (e.g., no data transmitted outside a user's private network) or a wide area network (e.g., encrypted data is transmitted using the Internet).

### 2. Activity Detection, Recognition, and Analysis

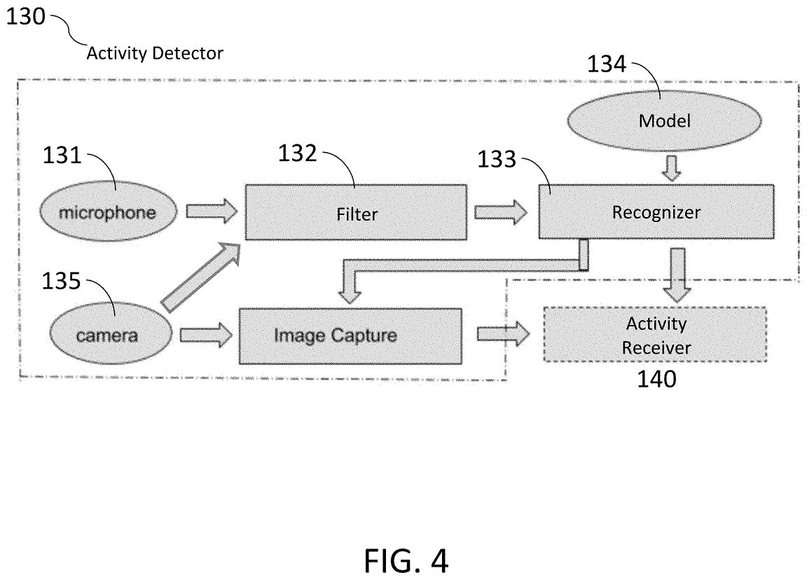

FIG. 4 shows a schematic diagram of various components and functions in the activity detector 130. The activity detector 130 may include a microphone 131 to record an audio stream in the input 102 from the environment. The activity detector 130 may also include a camera 135 to capture an image or record a video stream in the input 102. The camera 135 may be integrated into the activity detector 130 (e.g., a smartphone, a tablet) or may be externally coupled to the processor (e.g., a web camera, a Bluetooth camera) using a wired connection or a wireless connection. The activity detector 130 may also include a processor (not shown) that provides a filter 132 to detect, for example, sound activity and/or objects and a recognizer 133 to perform sound recognition and/or object recognition. The recognizer 133 may also generate and send a message 112 with a notification of the detected sound and/or object to the activity receiver 140.

In some cases, the activity detector 130 may be configured to trigger the microphone 131 or the camera 135 based on the detection of a sound or an object. For example, the detection of a sound of interest may trigger the camera 135 to capture an image or a video of the environment to correspond with the sound of interest detected.

As mentioned above, the activity recognition system 100 may be designed to operate in the background, thus allowing the user to use the activity detector 130 and/or the activity receiver 140 for other functions. For instance, in conventional video-based security systems, the camera is configured to provide a continuous stream of video. If such systems were to be deployed using a consumer electronic device, the user would be prohibited from using the device for other activities (e.g., video chatting). Furthermore, conventional security systems do not allow the activity detector 130 to operate in a covert mode (e.g., the microphone 131 records audio without providing live feedback, the camera 135 records an image/video without providing live feedback). For example, if the activity detector 130 includes a camera 135, the camera 135 may be configured to capture an image or video only when the camera 135 is not being used for another application.

### 2.1 Sound Filtering

The activity detector 130 may include a filter 132 with a processor that is used, in part, to filter out audio with low sound levels (e.g., silence, or background noise with a sound signal to noise ratio less than −10 dB) recorded by the microphone 131 thus allowing only portions of the audio stream containing sounds in the input 102 to be processed. By filtering out this audio, the amount of audio data collected by the activity detector 130 is reduced, thus increasing the computational efficiency. Additionally, the removal of this audio may also reduce the false alarm rate. Various factors are considered in the design of the filter 132 including, but not limited to, robustness against sound energy level, close to real time computation speed, and low computation complexity. For example, the quality of a sound, e.g., the signal energy, may degrade over longer distances or if multiple obstructions are present between the object emitting the sound and the activity detector.

In one example, the activity detector 130 may continuously record an audio stream 102 using the microphone 131. The filter 132 may segment the audio stream 102 into a series of continuous frames where each frame contains a portion of the audio stream represented by a sound level as the audio stream 102 is being recorded. In some systems, the portion of the audio stream contained in consecutive frames may overlap in order to enable a series of frames to be more easily stitched together to form a longer audio segment. Each frame may span from approximately 10 ms to 1 s of the audio stream 102. Each frame in the series of frames may be substantially equal in duration.

The filter 132 may use several levels of filters to extract an audio segment containing a detected sound. For example, a lower level sound activity filter may be applied to the portion of the audio stream 102 in each frame. The lower level filter may define a threshold where if the sound level is greater than or equal to the threshold, the frame is kept for subsequent processing. If the sound level of a frame is less than the threshold, the frame may be removed from the series of frames, thus reducing the amount of data stored and processed. The threshold may be chosen to balance between the false alarm rate and the rate at which sounds in the frame are not detected. In some instances, a frame with a sound level less than the threshold may not be removed from the series of frames, but instead be categorized as being inactive for possible removal depending on the configuration of a higher level filter. Frames having a sound level greater than the threshold are categorized as being active.

The sound level used in the lower level filter may be an integrated sound amplitude over the duration of the frame. The sound level may also be determined from the frequency spectra of the audio stream in the input 102 in each frame by applying, for example, a fast Fourier Transform to transform the audio stream from a time domain representation to a frequency domain representation. In one example, the sound level may be a spectral amplitude that varies as a function of frequency. When the sound level at one or more frequencies exceeds the threshold corresponding to the same frequencies, the frame may be kept in the series of frames for further processing. The threshold may also vary as a function of frequency. For instance, the activity recognition system 100 may be configured to be more sensitive to low frequency sounds by reducing the threshold at low frequencies.

In another example, a Gaussian mixture model may be used to model the frequency components of various sounds that can be detected by the activity recognition system 100. A Gaussian mixture model may also be used to model background noise or audio with low sound levels (e.g., silence). The frequency spectra of the audio stream may then be fitted with one or more Gaussian mixture models representing the various sounds that can be detected and the Gaussian mixture model representing background noise or low sound level audio.

A likelihood ratio may be determined by comparing the fitted Gaussian mixture models corresponding to the detectable sounds and the Gaussian mixture model representing background noise or low sound level audio. For example, the likelihood ratio may be calculated by integrating a first Gaussian mixture model, fitted to a peak in the frequency spectra corresponding to one sound, over a range of frequencies of the first Gaussian mixture model. A second Gaussian mixture model representing background noise may be also be integrated across the same range of frequencies as the integral of the first Gaussian mixture model. The range of frequencies of the first Gaussian mixture model may correspond, for example, to the full-width half-maximum of the first Gaussian mixture model or one or more standard deviations of the first Gaussian mixture model. The likelihood ratio may then be calculated by dividing the integral of the first Gaussian mixture model by the integral of the second Gaussian mixture model.

In this example, the sound level may be represented as the likelihood ratio and, hence, compared to the threshold. The threshold may also vary as a function of frequency, in which case the threshold may also be integrated over the same range of frequencies as the first Gaussian mixture model. If the likelihood ratio is appreciably larger than the threshold, then the frame may be kept in the series of frames for further processing. In this manner, the likelihood ratio can be used to ascertain whether the audio stream 102 contains a sound or only background noise/audio with low sound levels.

The likelihood ratio and the threshold may be unitless (e.g., the threshold is about 1). Additionally, the likelihood ratio may be determined across a range of frequencies that may include multiple peaks in the frequency spectra. Sub-band energy features may also be computed using, for example, a Fourier Transform may also be used to filter silence/noise. Furthermore, the threshold may be dynamically adjustable based on the detected background noise of the environment.

A higher level sound activity filter may also be used concurrently with the lower level sound activity filter. The higher level filter may be applied to a subset of frames in the series of frames. The subset of frames may be a consecutive subset of frames. The higher level filter may be configured to be a moving window where the first frame in the subset of frames (e.g., the earliest recorded frame) is removed when a new frame is added to the subset of frames (e.g., the latest recorded frame).

In one example, the higher level filter may be a two-state machine where state 1 represents no detection of sound and state 2 represents the detection of sound. The higher level filter may be applied to several consecutive frames spanning a fixed period of time. The period of time may be greater than or equal to about 300 milliseconds. As described above, the subset of frames monitored by the higher level filter will change as new frames are added to the series of frames. When the higher level filter is in state 1, the proportion of active frames in the subset of frames is monitored. If the higher level filter detects the proportion is greater than or equal to about 90%, the higher level filter will transition to state 2. Otherwise, the higher level filter will remain in state 1. In state 2, the higher level filter will instead monitor the proportion of inactive frames in the subset of frames. If the proportion of inactive frames is greater than or equal to about 90%, the higher level filter will transition back to state 1. Otherwise, the higher level filter will remain in state 2.

Thus, the higher level filter may extract a subset of frames from the series of frames that includes the earliest frame when the higher level filter transitioned from state 1 to state 2 and the latest frame when the higher level filter transitioned from state 2 to state 1. This subset of frames represents the audio segment that is then passed to a recognizer 133 for identification of sounds contained in the audio segment. The thresholds to determine the transition from state 1 to state 2 or vice versa and the period of time monitored by the higher level filter may vary depending, in part, on a balance between the false alarm rate and the rate at which sounds are not detected as well as the desired time response to a potential sound of interest.

Additionally, the audio segment extracted by the higher level filter may contain frames with sound levels less than the threshold of the lower level filter. For example, the audio segment may include two periods with sound separated by a period with no sound. Thus, frames having sound levels less than the threshold of the lower level filter may not be removed from the series of frames unless the higher level filter is in state 1.

The activity detector 130 may also include a buffer (e.g., memory in a sound card in a personal computer) to temporarily store portions of the audio stream 102 until the buffer has sufficient audio data to be then sent to the filter 132. In some instances, the filter 132 may operate sufficiently fast such that the filter 132 may wait for data to accumulate in the buffer (e.g., the filter 132 processes 10 seconds of audio data in 0.1 seconds).

### 2.2 Sound Recognition

Once the audio stream in the input 102 is filtered by the low level and high level filters, the resultant audio segments are then passed onto the recognizer 133 for identification of one or more sounds contained within the audio segment. The recognizer 133 may utilize a model 134 that is calibrated to identify a sound (the output) based on the frequency spectra of an audio segment (the input). Various types of models may be used including, but not limited to hidden Markov model, random forest, support vector machines, convolutional neural network, time delay neural network, and attentions.

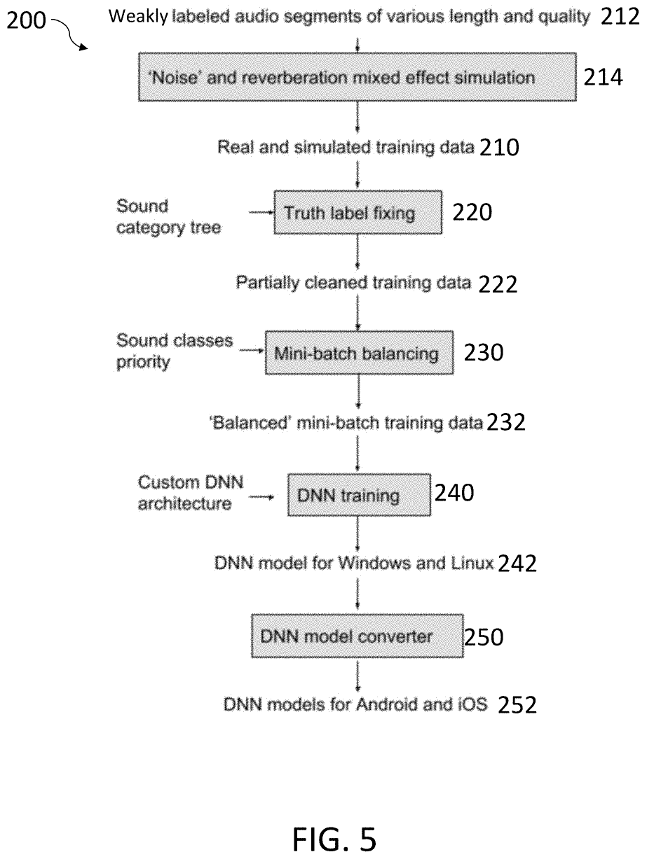

In one example, a deep neural network is used as a sound recognition model in the model 134 to identify multiple sounds. The user can select the number of sounds the sound recognition model can identify from the library of sounds when configuring the activity recognition system 100. Unidentified sounds may also be grouped together and labeled as an unknown sound. Such sounds may be passed along to the user for subsequent review. One exemplary process 200 to create the sound recognition model using the deep neural network is shown in FIG. 5.

The training process 200 may include the following steps: (1) generating real and simulated data for training the model in step 210, (2) labeling the training data with predetermined types of sounds that are present in the training data in step 220, (3) adjusting the relative contributions of each sound type in the training data as desired in step 230, (4) training the deep neural network (DNN) to identify the sounds present in the training data in step 240, and (5) converting the trained DNN for use in a desired operating system in step 250.

In step 210, the training data may be constructed from one or more training tokens where each training token is based on the real and simulated sound data. The training token includes an audio segment, which may contain one or multiple sounds, background noise, or audio with low sound levels (e.g., silence). If multiple sounds are included, the sounds may overlap in time and/or in frequency. The training token may also vary in duration. Similar sounds may also be grouped according to a sound class. For instance, one exemplary sound class may relate to fire alarms and includes sounds emitted by various types of fire alarms.

The training data may include upwards of millions of training tokens. The training data may also be labeled using a binary vector (e.g., 0 or 1) to indicate whether a sound class is present within the training data. The training data may also include weakly labeled audio segments 212 where the data does not have a precise timing label for each sound within the training data.

The training data may also incorporate background noise and reverberation effects 214 modelled using simulated data. For example, an interior space with a particular geometry may be represented by a room impulse response (RIR), which represents the decay of a time domain signal (e.g., an acoustic signal) with multiple frequency components as the signal propagates within the interior space. In order to simulate background noise and reverberation effects 214, training data may be generated for a large variety of room geometries. For each room geometry, a simulated microphone and a sound source can be placed in various locations within the simulated room.

Training data may also be generated, in part, using experimentally measured sound data by computing the convolution of the measured sound data with the RIR functions of each room. In other words, measured sound data may be modified by the RIR function to produce additional training data with background and reverberation effects.

In step 220, the training data may be labelled according to one or more sound classes. The sound classes may be organized using a hierarchy tree to provide multiple levels of sound classification. For example, a parent node in the hierarchy tree may correspond to sounds related to speech. The parent node may then have separate child nodes for speech from a man and a woman. The training method may use the hierarchy tree to automatically label sounds according to a preferred level of sound classification to ensure the training data is labelled in a similar manner. The output of step 220 is training data 222 that is at least partially labelled according to the sound classes.

The background noise may also be treated as a sound or a sound class. Thus, when labeling simulated data in step 220, a weighted combination of various sounds, including the background noise, is used. The weights represent the estimated relative energy level of the various sounds including the background noise. In this manner, sounds, background noise, and reverberation effects are included together in the sound recognition model 134, which enables the simulated data to be a more realistic representation of sounds encountered in the environment. Compared to conventional approaches that model background noise and reverberation effects separately, the approach disclosed herein does not separate background noise or reverberation from the original audio stream. This enables the activity recognition system 100 to identify multiple sounds occurring simultaneously within a complex environment using a single microphone. For example, the activity recognition system 100 can detect and identify sound emanating from a lower floor of a multi-story house when the activity detector 130 is located in an upper floor.

In step 230, the training data may then be adjusted and/or balanced to increase or decrease certain sound types. This may be accomplished by changing the distribution of training tokens used to form the training data. For example, the training data may be unbalanced to have a larger proportion of training tokens containing speech and a smaller proportion of training tokens containing coughing sounds. Unbalanced training data may be used, for example, to prioritize sounds of interest in the training data such that the sound recognition model 134 can be trained to identify the sounds of interest with greater accuracy and/or in a shorter amount of training time. Unbalanced training data may be used with the mini-batch gradient descent method where each mini-batch contains a larger proportion of training tokens related to the sounds of interest to enable the sound recognition model to convergence faster for those sounds of interest. The output of step 230 is training data 232 that is balanced (or rebalanced).

In step 240, the training data is then used to train the deep neural network. Various training methods may be used to train the model 134 including, but not limited to, a gradient descent method, a mini-batch gradient descent method, or a stochastic gradient descent method. The output of step 240 is a trained deep neural network, which serves as the sound recognition model 134.

The trained model deep neural network may be saved in different formats for compatibility with various operating systems including, but not limited to, Microsoft Windows, Linux, Google Android, and Apple iOS operating systems. In step 250, the trained deep neural network may be converted for use in a desired operating system for deployment.

The training method disclosed in FIG. 5 may be computationally inexpensive. For example, the sound recognition model 134 may be trained using at least one million sound segments over a period of 1-2 days using a single personal computer with a single Graphics Processing Unit (GPU) card. The trained model 134 may have a small file size (e.g., on the order of tens of megabytes corresponding to about 500 unique sounds), which is small footprint that can be readily accommodated using conventional consumer electronic devices such as a PC, tablet, or a smartphone.

Additionally, the sound recognition model 134 may also be configured such that a preferred threshold value is used for each sound class based on the training data. In some instances, the threshold value may be fixed during operation of the activity recognition system 100. In some instances, the threshold value may dynamically change to adapt to different environments with varying levels of background noise. In this manner, the threshold value can be tuned to balance the false alarm rate and the missing detection rate on a per sound class basis rather than the audio segment in its entirety. The activity recognition system 100 may be configured to maintain the false alarm rate to be less than 1% for all sounds of interest selected by the user.

### 2.3 High-Level Sound Recognition

As described above, the sound recognition model 134 may be used to predict the probability of multiple sound classes in an audio segment of any length. A threshold specific to a particular sound class may be used to determine whether the sound class is detected within the audio segment. The activity recognition system 100 may also further use sound semantics to infer a high-level event from multiple, more basic sounds detected by the system. The high-level event may be a name or a description of an activity associated with the detection of multiple basic sounds.

For example, when ‘glass’ and ‘shatter’ sounds are detected within the same audio segment, the sound recognition model can output ‘window break’ as the high-level event. Sound semantics may be based on predefined rules that define a relationship between certain sounds. In some instances, a model (e.g., the model 134 or another model incorporating the model 134) may be trained to relate different sounds rather than using predefined rules. Various types of models may be used including, but not limited to hidden Markov model, random forest, support vector machines, convolutional neural network, time delay neural network, and attentions.

### 2.4 Object Recognition and Camera Operation

The activity detector 130 may also include a camera 135, coupled to the microphone 131 and the processor, to acquire an image or a video (e.g., a series of images) of the environment. The image(s) or video may be used to detect objects of interest (e.g., a person, a car) in the environment. The video may also be used to detect video activity including motion-based events such as a person walking or jumping. When the camera 135 records a video as a series of images, the images may be acquired in time intervals ranging between about 1 s to about 10 s.

The image(s) or video recorded by the camera 135 may be passed to the filter 132 to process and improve visual quality. For example, the filter 132 may normalize the brightness of the image(s), especially if the contrast inhibits the identification of objects in the image. In another example, the filter 132 may reduce noise in the image(s) to reduce false alarm rates caused by the erroneous detection of objects.

The image(s) or video may be passed to the recognizer 133 to detect objects of interest in the image. Objects of interest may be selected by the user for detection similar to the selection of the sounds of interest. In some instances, the objects of interest may be associated with certain sounds of interest. The selection of a sound of interest may also determine the object of interest for detection. For example, the sound of a door opening may be associated with a visual depiction of a person. The recognizer 133 may recognize objects in a similar manner to sound recognition. The model 134 may include an image recognition model that is calibrated to identify an object (the output) based on the pixel values, i.e., grayscale values, red-green-blue values of the image (the input). Various types of models may be used including, but not limited to hidden Markov model, random forest, support vector machines, convolutional neural network, time delay neural network, and attentions.

In one example, a deep neural network may be used as the image recognition model to identify one or more objects. Again, similar techniques used for the sound recognition model may also be used for the image recognition model. For example, the training data may include both real and simulated imaging data. The training data may again be constructed from one or more training tokens. In this example, the training token may include an image with one or more objects and/or background noise. A real image of an object may be subsequently altered (e.g., changing the location of the object in the image, changing the color of the object, changing lighting conditions on the object by altering brightness/contrast) to produce additional images for training. The arrangement of these objects may also be altered (e.g., objects may overlap one another) to produce additional training data. Similar objects may also be grouped together according to an object class. A hierarchy tree may also be used to provide multiple levels of classification of the objects similar to hierarchy tree used for sound classification, as described above.

The camera 135 may be configured to operate concurrently with the microphone 131. The camera 135 may acquire images at regular intervals (e.g., ranging between about 1 s to about 10 s) while the microphone 131 continuously records audio. By using both image recognition and sound recognition techniques, the activity recognition system 100 can provide greater awareness of the environment being monitored. For instance, if a person is breaking into a house, there is a possibility the person may not make sounds detectable by the microphone 131 (e.g., the person is out of range from the microphone). However, the use of the camera 135, which may have a longer operating range than the microphone 131, may still be able to detect the person.

The detection and identification of an object of interest may trigger the microphone 131 to record audio to capture sounds associated with the object. The detection and identification of a sound of interest may also trigger the camera 135 to acquire an image of the environment in order to visually capture the source of the detected sound. The image and the audio from the sound recognizer 133 may both be labeled (e.g., with a timestamp or event marker) by the processor such that the user can identify the image and the audio as being related to the same event. In one example, the image and the audio may then be directly transferred to the activity receiver 140 or uploaded to the server 180 (e.g., a cloud server) for subsequent access by a user. Additionally, the message 122 sent to the user may also include a notification that an image was taken in response to the detection of sound.

In another example, image recognition may be applied to determine whether an object of interest is present in the image. If an object of interest is detected, the message 122 sent to the user may also include a notification that an image with the object of interest was acquired in addition to the recorded audio. Returning to the example of a person breaking into a house, once a sound of interest (e.g., broken glass, door opening) is detected, the camera 135 can then be triggered to take an image. If the image is determined to include the person, the user can then be sent a message 122 with links to both the image and the audio. By providing the user both visual and auditory data, the user can make a more informed decision whether to alert the authorities of a break-in in their home. Additionally, the image may also be subsequently used to help identify the person.

In yet another example, the activity recognition system 100 may include multiple cameras 135 to cover an environment from multiple perspectives. When a sound of interest is detected, each camera 135 may be triggered to acquire an image. The image recognition techniques described above may then be used to ascertain which images contain an object of interest. The image containing the object of interest may then flagged for a user to review. Returning again to the example of a person breaking into a house, multiple images from multiple cameras 135 may be acquired when a sound of interest (e.g., broken glass, door opening) is detected. The activity detector 130 may then be configured to only transmit the images that show the person to the activity receiver 140 (or the server 180). In this manner, only visual data pertinent to the sound of interest is shown to the user.

Additionally, each camera 135 may acquire a series of images that are each timestamped. The image recognition methods described may be used to isolate the images that only show the person as a function of time. For example, a first camera 135 may take a first image at a first timestamp showing the person. This may then be followed by a second camera 135 taking a second image at a second timestamp showing the person. In this manner, a series of timestamped images can then be sent to the user showing the person as they move through the house.

### 2.5 Configurable Notification System

The activity recognition system 100 allows a user to configure where and how the message 122 is sent. For example, when used as an assisted hearing system for the deaf, the activity recognition system 100 may be deployed using a smartphone owned by the person with the hearing disability as both the activity detector 130 and the alert receiver 140. The alert receiver 140 may receive a text message when a sound of interest is detected based on the phone number of the smartphone. For remote monitoring applications, the activity recognition system 100 may include the user's home computer as the activity detector 130 and the user's personal phone as the alert receiver 140. Thus, a message 122 may be sent as a text message or an email to a user's personal phone.

As described above, the activity recognition system 100 may also be configured such that recorded audio segments, photos, or videos are made accessible online through the cloud service 120. Additionally, a user may specify when to run the activity recognition system 100, select sounds of interest and/or objects of interest, set the frequency the messages are sent to the alert receiver 140, and powering on/off the activity recognition system 100. The activity recognition system 100 may also generate a summary of detected sounds and/or objects for various periods of time (e.g., daily, weekly). As mentioned above, the recorded audio segments containing a sound of interest, photos, or video segments containing the objects of interest may be saved locally on the activity detector 130 and/or the activity receiver 140. Again, the user can choose whether this data is uploaded and thus also accessible through the cloud service.

### 3. Application Domains

The activity recognition system 100 can be configured for various applications based on a user's preferences. Several applications are hereafter listed; however, it should be appreciated by one of ordinary skill in the art that more applications may be conceivable for the activity recognition system 100 disclosed herein.

### 3.1 A Sound-Based Security System

The activity recognition system 100 may be used as a security system deployed at home, a business, a school, or a public space. For example, the activity recognition system 100 may be deployed using a user's PC, tablet, or smartphone as the activity detector 130 and/or the activity receiver 140. The user may configure the activity recognition system 100 to detects sounds related to a threat or a security breach, such as a smoke detector alarm, the breaking of glass break, a gunshot, a doorbell, a door slamming shut and forced open, and so on as the sounds of interest. The user can configure the activity recognition system 100 such that the user's phone receives text messages containing an alert of a potential security risk. The text message may contain links to the detected audio and photo available online. In this manner, the activity recognition system 100 functions as a remote sound security system.

### 3.2 A Sound-based Health Monitoring System

The activity recognition system 100 may be used as a sound-based health monitoring system. For example, the activity recognition system 100 may be configured to detect sounds related to symptoms of various illnesses or ailments, such as coughing, sneezing, and so on as the sounds of interest. Depending on the severity of the illness or ailment, the user can configure the activity recognition system 100 such that the receiver 140 receives a daily summary of the type, number, and frequency of sounds detected. The activity recognition system 100 may also be used to monitor sleep quality by detecting sounds such as snoring or a rolling over motion of a person in bed during nighttime hours as the sounds of interest. Again, a daily or weekly summary of the type, number, and frequency of detected sounds can be provided.

### 3.3 Baby Monitoring

Conventional baby monitoring systems typically have a very limited range of operation (e.g., a few hundred feet) between the detector and the receiver. The activity recognition system 100 can be configured to detect the sounds of a baby crying as the sound of interest. Given the manner in which detected sound data is transmitted to the activity receiver 140, the activity recognition system 100 may be used to convert a computer and cellphone as a remote baby monitor with almost unlimited range. Additionally, this large range of operation can also be useful to monitor the quality of a babysitting service based, in part, on a summary of total amount of time a baby cried while under the care of a babysitter.

### 3.4 Pet Monitoring

The activity recognition system 100 may also be configured to detect pet-related sounds such as a dog barking, a cat meowing, a bird chirping as the sounds of interest. This can be used to monitor the activity of pets, particularly when their owners are away from home.

### 3.5 Emergency Evidence Collection and Prevention

Emergencies in various environments including a home, a school, a public area, or a prison can occur. When emergencies occur, the activity recognition system 100 can be used as an evidence gathering tool by providing a record of sounds related to the emergency as the emergency was unfolding. Additionally, the activity recognition system 100 may also be used to alert security or police of an imminent emergency by sending a message to the aforementioned personnel. For example, the sounds of interest may include yelling, shouting, crying, objects breaking, and so on.

### 3.6 Assisted Hearing for the Deaf

The activity recognition system 100 may also be configured as an assisted hearing system for the deaf or hearing impaired. For example, the activity recognition system 100 may be configured to detect common sounds encountered daily everyday life. Combined with real-time operation, the activity recognition system 100 can increase situational awareness by informing the user of sounds occurring in their immediate environment.

### 3.7 Sound-based Assisted Driving System for Automotive Vehicles

The activity recognition system 100 may also be used to increase situational awareness of a driver operating a vehicle or an autonomous driving system. For example, the activity recognition system 100 may detect the sirens of an ambulance, a fire truck, or a police car beyond the field of view of a driver or a radar-based system. Additionally, the sounds of a bicycle bell, another motor vehicle, or a train can provide valuable information to increase the safety of a driver-operated vehicle or an autonomous vehicle, particularly when visibility is reduced.

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of detecting and identifying at least one sound of interest, the method comprising:
recording an audio stream using a microphone disposed in an activity detector;
detecting a sound from the audio stream using a processor disposed in the activity detector, the processor being operably coupled to the microphone;
in response to detecting the sound, identifying the sound as at least one predetermined sound in a plurality of predetermined sounds using the processor;
comparing the at least one predetermined sound to the at least one sound of interest using the processor;
in response to matching the at least one predetermined sound to at least one sound of interest, generating a message using the processor, the message including text identifying the at least one sound of interest;
transmitting the message using a transmitter coupled to the processor; and
receiving the message using an activity receiver.

2. The method of claim 1, wherein the processor in the activity detector does not communicate with another processor that is physically separate from the activity detector before transmitting the message using the transmitter coupled to the processor.

3. The method of claim 1, wherein the sound is a non-verbal sound.

4. The method of claim 1, further comprising, in response to matching the at least one predetermined sound to at least one sound of interest:
acquiring an image using a camera coupled to the processor;
in response to a contrast of the image preventing identification of objects in the image, normalizing a brightness of the image; and
identifying an object in the image that is generating the at least one sound of interest.

5. The method of claim 1, wherein the audio stream is segmented into a series of frames, each frame containing a portion of the audio stream.

6. The method of claim 5, wherein the portion of the audio stream in each frame has a sound level, and wherein detecting the sound from the audio stream using the processor comprises:
applying a first filter to each frame, the first filter having a threshold such that the frame is inactive when the sound level of a frame is less than the threshold and the frame is active when the sound level of the frame is greater than or equal to the threshold; and
applying a second filter to the series of frames, the second filter being configured to extract a subset of frames from the series of frames such that the subset of frames is substantially comprised of active frames, the subset of frames being the sound.

7. The method of claim 6, wherein the sound level is a spectral amplitude of the audio stream, and wherein the sound level and the threshold are frequency dependent.

8. The method of claim 6, wherein the sound level is represented as a likelihood ratio, and wherein applying the first filter to each frame comprises:
representing the sound using a first Gaussian mixture model;
representing background noise using a second Gaussian mixture model; and
calculating the likelihood ratio using the first Gaussian mixture model and the second Gaussian mixture model.

9. The method of claim 6, wherein applying the second filter comprises:
monitoring a first plurality of frames, the first plurality of frames being a subset of the series of frames;
while monitoring the first plurality of frames, determining a first proportion of frames in the first plurality of frames that are active frames;
in response to the first proportion being at least 90%, monitoring a second plurality of frames, the second of frames being a subset of the series of frames;
while monitoring the second plurality of frames, determining a second proportion of frames in the second plurality of frames that are inactive frames; and
in response to the second proportion being at least 90%, extracting the subset of frames, the subset of frames comprising the first plurality of frames with the first proportion being at least 90% and the second plurality of frames with the second proportion being at least 90%.

10. The method of claim 9, further comprising:
while monitoring the first plurality of frames and in response to the first proportion being less than 90%, removing the inactive frames from the first plurality of frames to reduce a false alarm rate and to increase a computational efficiency of the processor.

11. The method of claim 9, wherein identifying the at least one predetermined sound in the plurality of predetermined sounds comprises:
inputting the subset of frames into a model trained with training data to identify the plurality of predetermined sounds; and
outputting the identity of the at least one predetermined sound.

12. The method of claim 11, wherein the training data is at least one of experimental data or simulated data containing two or more predetermined sounds that overlap, at least in part, in at least one of a time domain or a frequency domain.

13. The method of claim 11, wherein the training data is simulated data that includes at least one of background noise or reverberation effects, the reverberation effects being simulated using a Room Impulse Response (RIR) representing one or more room geometries.

14. The method of claim 1, wherein the at least one sound of interest is a first subset of the plurality of predetermined sounds, and further comprising, after receiving the message using the activity receiver:
changing the at least one sound of interest to a second subset of the plurality of predetermined sounds different form the first subset.

15. The method of claim 1, further comprising, after transmitting the message using the transmitter and before receiving the message using the activity receiver:
receiving and storing the message using a server operably coupled to the activity detector and the activity receiver; and
transmitting the message from the server to the activity receiver.

16. A method of detecting and identifying at least one sound of interest, the method comprising:
recording an audio stream using a microphone disposed in an activity detector;
detecting a sound from the audio stream using a processor disposed in the activity detector, the processor being operably coupled to the microphone;
in response to detecting the sound, identifying the sound as at least one predetermined sound in a plurality of predetermined sounds using the processor;
comparing the at least one predetermined sound to the at least one sound of interest using the processor;
in response to matching the at least one predetermined sound to at least one sound of interest, generating a message using the processor, the message including text identifying the at least one sound of interest;
transmitting the message using a transmitter coupled to the processor;
receiving and storing the message using a server operably coupled to the activity detector and the activity receiver; and
transmitting the message from the server to the activity receiver,
wherein before transmitting the message using the transmitter coupled to the processor, the processor in the activity detector does not communicate with another processor that is physically separate from the activity detector.

17. An activity recognition system comprising:
an activity detector configured to identify a plurality of predetermined sounds, the plurality of predetermined sounds including at least one sound of interest, the activity detector comprising:
a microphone to record an audio stream;
a processor electrically coupled to the microphone, the processor being configured to:
detect a sound from the audio stream;
identify at least one predetermined sound in the plurality of predetermined sounds from the sound;
generate a message in response to matching the at least one predetermined sound to the at least one sound of interest;
a transmitter, electrically coupled to the processor, to transmit the message; and
an activity receiver, operably coupled to the activity detector, to receive the message.

18. The activity recognition system of claim 17, wherein the activity detector further comprises:
a camera, operably coupled to the processor, to acquire an image in response to matching the at least one predetermined sound to at least one sound of interest, the image having a brightness that is normalized in response to the image having a contrast that prevents identification of objects in the image.

19. The activity recognition system of claim 17, wherein the activity detector is a mobile phone.

20. The activity recognition system of claim 17, wherein the processor is not communicatively coupled to a server.
